(19) United States
(12) Patent Application Publication
(10) Pub. No.: US 2024/0219273 A1
(43) Pub. Date: Jul. 4, 2024

(54) IMMUNOAFFINITY LIGANDS IMMOBILIZED ON POROUS MEMBRANES

(71) Applicant: Waters Technologies Corporation, Milford, MA (US)

(72) Inventor: Lingyun Chen, Westborough, MA (US)

(73) Assignee: Waters Technologies Corporation, Milford, MA (US)

(21) Appl. No.: 18/390,234

(22) Filed: Dec. 20, 2023

Related U.S. Application Data
(60) Provisional application No. 63/477,476, filed on Dec. 28, 2022.

(51) Int. Cl. G01N 1/34

(52) U.S. Cl. CPC G01N 1/34

(57) ABSTRACT

The present disclosure describes a system for purifying and enriching a sample and methods of making and using thereof. The system has immunoaffinity ligands immobilized on one or more of a three-dimensional porous membrane secured in a device such that the membrane is capable of immunoaffinity binding a target compound when a sample is aspirated or expelled from the device as the sample passes through the membrane.

### RELATED APPLICATION

This application claims priority to and the benefit of U.S. Provisional Application No. 63/477,476, filed Dec. 28, 2022, the entire disclosure of which is incorporated herein by reference.

### FIELD OF THE TECHNOLOGY

The present technology generally relates to devices and methods for immunoaffinity purification. In particular, the present technology relates to devices and methods incorporating immunoaffinity ligands immobilized on three-dimensional porous membranes for sample extraction and purification.

### BACKGROUND

Immunoaffinity purification is a sample preparation technique that facilitates chemical and clinical diagnostics. Immunoaffinity ligands (e.g., antigens/antibodies) are typically immobilized on resins and packed in a column barrel to form an immunoaffinity column. That is, in a conventional device, the immunoaffinity ligands are attached or associated with a resin packed within a column or cartridge.

These conventional immunoaffinity columns can be problematic as they are relative expensive due to poor manufacturability. It is also a tedious procedure to couple the immunoaffinity ligands onto the resins. Installation involves top and bottom frits and resin. The top frit demands a well-controlled process. Since the resins are packed and stored in storage buffer, the columns need to be sealed properly to prevent leakage. Air bubbles trapped in the resin bed has been a common issue observed.

Another problem is poor stability of the immunoaffinity ligands in solution. Conventional immunoaffinity columns are typically stored refrigerated to extend the shelf life. This refrigeration requirement makes the columns difficult to handle. The column's top and bottom caps and storage buffer need to be removed before use. Depending on the consistency of the resin packing, column back pressure varies, which leads to inconsistent flow rate affecting the recovery. As a result, resin-based immunoaffinity columns are not compatible with high throughput automation systems.

### SUMMARY

The present technology solves the problems associated with the prior art by using immunoaffinity ligands immobilized onto porous membrane materials. That is, the immunoaffinity ligands are associated with a porous three-dimensional structure (i.e., membrane) extending across the fluidic passageway of the column. The porous three-dimensional membrane is secured to interior walls defining the fluidic path and not packed with a resin within the body of the column as in conventional devices.

In an aspect, the present technology is directed to a system for purifying and enriching a sample comprising immunoaffinity ligands immobilized on one or more of a three-dimensional porous membrane wherein the membrane is secured in a device such that the membrane is capable of immunoaffinity binding to a target compound when a sample is aspirated or expelled from the device as the sample passes through the membrane.

In some aspects, the device comprises a column, pipette (e.g., pipette tip) cartridge, or a syringe.

In some aspects, the immunoaffinity ligands are immobilized on the membrane by covalent bonding. In some aspects, the immunoaffinity ligands are immobilized on the membrane by passive absorption.

In some aspects, the membrane is dry when not in contact with a sample.

In some aspects, the membrane comprises a porous polymer such as a plastic polymer. In some aspects, the immobilized immunoaffinity ligands are capable of capturing from less than about 5% to 100% by weight of the target compound from the sample based on the total weight of the target compound present in the sample before the extraction and purification steps described herein. In some examples, the immobilized immunoaffinity ligands on the three-dimensional porous membrane capture less than 10% by weight; 10% by weight; 15% by weight; 20% by weight; 25% by weight; 30% by weight; 35% by weight; 35% by weight; 40% by weight; 45% by weight; 50% by weight; 55% by weight; 60% by weight; 65% by weight; 70% by weight; 75% by weight; 80% by weight; 85% by weight; 90% by weight; or 95% by weight; or greater than 95% by weight of the target compound based on the total weight of the target compound present in the sample before the extraction and purification steps described herein.

In some aspects, the system does not comprise (i.e., lacks) a resin capable of contacting the sample. That is, in some examples the system does not include resin packed in the column, pipette, cartridge or syringe.

In an aspect, the present technology is directed to a high throughput instrument comprising the system.

In another aspect, the present technology is directed to a method of purifying and enriching a sample by aspirating the sample into or expelling the sample from the system. For example, eluting the target compound bound to the porous three-dimensional membrane.

In another aspect, the present technology is directed to a method of making the system by immobilizing immunoaffinity ligands on one or more of a three-dimensional porous membrane and securing the membrane in a device such that the membrane is capable of immunoaffinity binding to a target compound when a sample is aspirated or expelled from the device as the sample passes through the membrane. For example, securing the membrane to interior walls forming the fluidic passageways, such that the membrane extends across a cross-section of the fluidic passageway. As a result of the placement of the membrane, the fluidic sample must pass through its porous.

### BRIEF DESCRIPTION OF THE DRAWINGS

The technology will be more fully understood from the following detailed description taken in conjunction with the accompanying drawings, in which:

FIG. 1 shows a flowchart of using the immunoaffinity ligand system.

FIG. 2 shows positioning of a porous three-dimensional membrane with immobilized immunoaffinity ligands attached thereto.

FIG. 3 shows a side perspective cutout of a syringe with an embodiment of two porous three-dimensional membranes.

### DETAILED DESCRIPTION

In an embodiment, the present technology advantageously employs immunoaffinity ligands immobilized on one or more three-dimensional porous membranes in a system to purify and enrich samples containing a target compound. This advantageously eliminates the need for resins. In addition to eliminating the need for resin material, the devices, systems and methods allow for dry storage, thereby eliminating any need for refrigeration and other special handling or storage requirements.

The membranes in accordance with the present technology may be fixed or secured in device such that the membrane is capable of immunoaffinity binding to a target compound when a sample is aspirated or expelled from the device as the sample passes through the membrane. Thus, the membrane permits liquid samples to pass through while purifying and extracting the sample by binding the target compound with immunoaffinity ligand. Moreover, the design of the present purification technology permits at least two interactions of the sample with the immunoaffinity ligands on the membrane by virtue of the aspirating and expelling steps.

The porous three-dimensional membranes with immobilized immunoaffinity ligands extend across the fluidic passageway of the system or devices. As a result, the fluidic sample must pass through the porous three-dimensional membrane when the sample is passed therethrough. Moreover, the sample can be flowed through the device in one direction (i.e., a first direction) and then sucked through the porous membrane using a suction force in a second direction that is 180 degrees opposite from the first direction.

The target compound in the sample binds to the immunoaffinity ligand as the sample flows through the three-dimensional porous membrane. In some embodiments, either the target compound or the immunoaffinity ligand may be an antigen, antibody, or antibody-related reagent wherein the antigen binds to the antibody or antibody-related reagent. In a preferred embodiment, the immunoaffinity ligand is an antibody and the target compound is an antigen.

Devices for aspirating or expelling the sample are not particularly limited. In some embodiments, the device is capable of both aspirating and expelling from the same device. In preferred embodiments, the device is a pipette or syringe. In some embodiments, the device contains a column or barrel chamber portion (e.g., a cartridge) for passage of the liquid sample. The system can contain multiple devices. For example, the system can contain a plurality of pipette or pipette tips stored in racks. The devices may be further comprised in a high throughput automation system. For example, the present technology can be easily integrated into a high throughput automation system that uses a plurality of pipette tips arranged in racks or trays.

After the sample is removed from the device, the target compound is bound to the immunoaffinity ligands. The membrane may then be eluted with an elution solution that removes and collects the target compounds. Any elution may be utilized that is stable and compatible with the target compounds and immunoaffinity ligands.

Immobilization can be achieved by covalent bonds through functional groups or passive absorption or by non-covalent means. In some embodiments, the covalent means comprises a linker compound. Immobilization linkers are not particularly limited as long as they are stable, capable of long-term storage, and compatible with the membrane material and immunoaffinity ligand.

The membrane is a porous three-dimensional element and, thus, immunoaffinity ligands are immobilized on an entire membrane surface along an X, Y, and Z-axes.

The present technology advantageously does not need resin manufacturing and column packing procedures. In an embodiment, no resins are contained in the system or a device that may contact the sample. In an embodiment, the methods of the present technology do not comprise column packing.

The three-dimensional porous membranes after coating with immunoaffinity ligands can be dried, along with preservatives, to maintain the activity of immunoaffinity ligands. The device or column containing the immunoaffinity ligand-coated membranes can be stored dry (without top and bottom caps) at ambient temperature with extended shelf life, which also makes the device or column easy to manufacture and use. In some embodiments, the system further comprises a desiccant.

The immunoaffinity ligand-coated membranes can be stored separately or positioned within a device, such as, for example, a pipette tip, or narrow bore column. In both cases, no refrigeration is needed for storage. Moreover, as the immunoaffinity ligand-coated membranes can be stored in a dry state, less packaging and storage requirements are used as compared to conventional immunoaffinity columns.

The membrane material is not particularly limited. In some embodiments, the membrane material comprises a porous polymer. In some embodiments, the porous polymer is a ultra-high molecular weight polyethylene (UHMWPE), high-density polyethylene (HDPE), polypropylene (PP), polytetrafluoroethylene (PTFE), polyvinylidene fluoride (PVDF), ethylene vinyl acetate (EVA), polyethersulfone (PES), polyurethane (PU), and/or PE/PP co-polymer. In some embodiments, the membrane material is a POREX® porous polymer material. Porex Corporation of Fairburn Georgia owns the trademark POREX® and sells porous plastic/polymer materials in connection with this registered trademark.

An advantage of porous polymers materials is that the material is flexible, which allows for placement and handling of the immunoaffinity ligand-coated membranes without damage. Another advantage of using porous polymers as the underlying three-dimensional membrane material is its tailorability of pore size surface area. For example, there are many techniques available for controlling and establishing the extent and size of pores within the material. Control over the pore size and density or amount of pores allows for tailoring or controlling the amount of immunoaffinity ligand material available for interaction with a fluidic sample.

In some embodiments, the porous polymer membrane is formed by securing a plurality of polymer fibers in a stack or woven together. In other embodiments, the porous polymer membrane is formed using a sol-gel process in which porosity is incorporated into the final membrane. Porosity maybe included by, for example, burning out sacrificial materials in a final processing step. In some embodiments, porous can be built in through an additive manufacturing process.

In some embodiments, the membrane material comprises a porous glass or porous ceramic material. The porous glass or ceramic material can have a woven or porous format formed by positioning of packing of fibers. For example, a plurality of glass fibers can be stacked and sintered together to form a three-dimensional membrane with open porosity.

In some embodiments, the membrane comprises a foam.

In some embodiments, the membrane comprises a metal, such as a metal mesh type structure.

In some embodiments, the membrane is a frit such as a frit typically used in a chromatography column to secure a stationary phase material in position.

The porous three-dimension membrane is not a two dimension or planar structure. Rather, the membrane of the present technology not only extends across the entire cross-section of the fluidic pathway of the device, but also has a thickness in direction perpendicular to the cross-section of the fluidic pathway. Exemplary thicknesses include, but are not limited to 50 microns, 100 microns, 300 microns, 350 microns, and 500 microns.

In some embodiments, the method of the present invention is capable of purifying the from about 1% to 99% by weight, 25% to 99% by weight, or 50% to 99% by weight of the target compound from the sample. The extent of purification depends on the pore surface area of the membrane and the type of immunoaffinity ligand and target compound that is being extracted. The amount of extracted target compound depends on the particular application. For example, 1 microgram of a recovered target compound may be sufficient in some applications, whereas 1 nanogram may be sufficient in others.

In some embodiments, the system and methods employ multiple membranes per device (e.g., 2, 3, 4, etc.). The thickness of each membrane is not particularly limited as long as the immobilized immunoaffinity ligands are capable of capturing the desired amount of target compound.

While not being bound by a specific theory, the present technology employs optimal membrane size and thickness based on the pore size. As pore size becomes smaller, surface area increases, which permits more immunoaffinity ligands to capture target compounds. However, as pore size gets smaller, back pressure resistance increases. Therefore, the present technology determines the optimal size based on these factors and the specific application. In one example, the pore sizes are substantially uniform throughout the membrane (i.e., ±2.5% change in pore size). In some examples, the pore volume is substantially uniform (i.e., ±2.5% change in pore volume). Exemplary pore sizes include, but are not limited to, 0.1 microns, 0.2 microns, 0.5 microns, 1 micron, 1.5 microns, and 5 microns pore sizes). Pore volumes can range between 0.005 and 0.1 cm³/g, in some examples.

In another embodiment, the present technology is a method of using the system to purify and enrich a sample by aspirating the sample into or expelling the sample from the system. After the target compound is extracted, the method may further involve eluting the target compound from the membrane by washing the membrane with an elution solution. Any eluant may be used as long it is compatible with the target compound and immunoaffinity ligands.

In another embodiment, the present technology is a method of making the system by immobilizing immunoaffinity ligands on one or more of a three-dimensional porous membrane, securing the membrane in a device such that the membrane is capable of immunoaffinity binding to a target compound when a sample is aspirated or expelled from the device as the sample passes through the membrane.

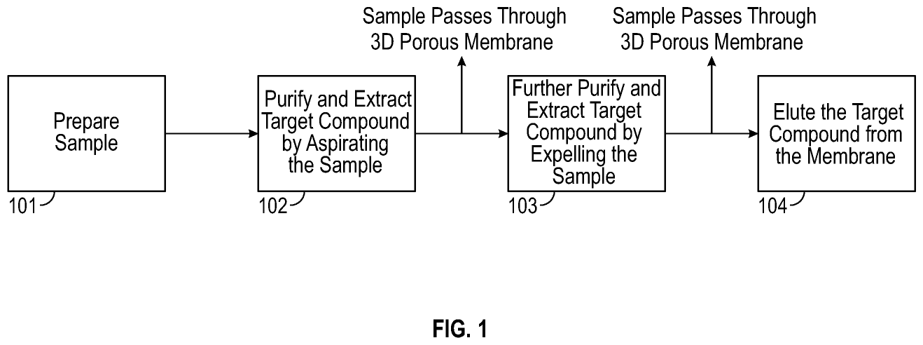

FIG. 1 presents a flow chart illustrating a method of sample purification/enrichment in accordance with the present technology. In step 101 a liquid sample is prepared containing a target compound. In the embodiment shown in FIG. 1, the method incorporates a device that aspirates the prepared sample. In other embodiments, the device need not aspirate the sample, but merely provide a passageway for the sample to flow through. In the method shown in FIG. 1, the second step, step 102, includes aspirating the sample to purify and extract a target compound. As the sample is aspirated, the sample passes through one or more of a three-dimensional porous membrane that is secured within the device. Extraction occurs as the sample passes through the membrane. The membrane has a plurality of immunoaffinity ligands that are immobilized on the surface that can interact and bind with the target compound when contacting the sample. In the embodiment shown in FIG. 1, the method includes a second opportunity to purify or enrich a sample. That is, the method of FIG. 1 allows for the sample to take a second pass through the immunoaffinity ligand-coated membrane by expelling the fluidic sample therethrough. This is an optional step—and it is noted that some embodiments of method in accordance with the present technology will not require a second purification step (i.e., the fluidic sample only passes through the membrane once in a single direction). In the embodiment shown in FIG. 1, step 103 provides a second extraction step. Specifically, in step 103, the sample can be further purified as any remaining target compound in the sample is potentially captured when the device expels the sample back through the membrane. Extraction based on steps 102 and 103 can occur as many times as desired to ensure maximum extraction. After the target compound is depleted from sample and the sample is expelled out from the device, an elution solution may be aspirated into and expelled from the same device (elution step 104). The elution solution elutes the target compound off membrane surface and into the resulting solution as the elution solution contacts the surface of the membrane. The resulting solution contains the purified target compound. Thus, the entire process extracts and purifies the target compound from the prepared sample.

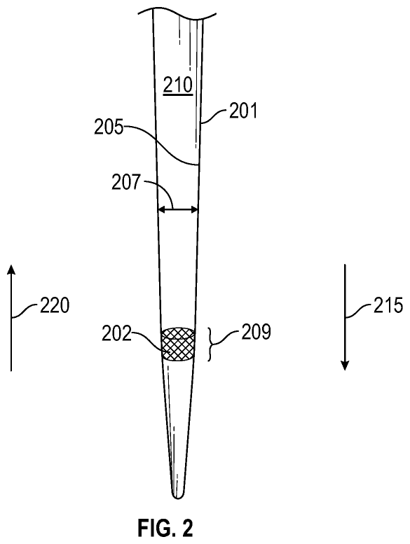

FIG. 2 shows a side perspective cross-sectional view of a pipette device 201 including a single three-dimensional porous membrane 202 having immunoaffinity ligands attached to the porosity within the membrane 202. The membrane 202 is a three-dimensional element and the immunoaffinity ligands (represented by crisscrossed lines) are immobilized on the membrane's entire surface, including the interior surface area (i.e., at least partially coating or lining along the pore surface area). The membrane 202 is secured within the pipette 201 at a desired location and extends across the entire cross-sectional area 207 of the pipette device 201. As shown in FIG. 2, the membrane 202 is secured to interior wall surfaces 205 of the pipette device 201. For example, the membrane 202 can be secured to the walls with by a friction-fit force. In other embodiments, the frit can be secured by a retaining mechanism (e.g., a gasket, retaining lip or hook) or by some type of adhesive or chemical/physical bond (e.g., heat activated). In general, it will be important for the membrane to extend across the entirety of the cross sectional area 207, such that the fluid sample passing through an interior 210 of the pipette device 201 must pass through the membrane 202 (and thus through the porosity with the immunoaffinity ligands).

The membrane is three-dimensional, and thus not only has a surface that extends across the entirety of the cross-sectional area 207 at its secured location, but also a thickness 209. The porous three-dimensional structure provided by membrane 202 creates the surface area to which the immunoaffinity ligands are attached—and creates passageways for the fluid sample to flow through allowing for sample interaction with the ligands. The arrows 215 and 220 on each side of the pipette 201 show the flow path of a sample containing the target compound as it is aspirated and expelled from the pipette. Each time the sample contacts and passes through the porous membrane 202, the target compound interacts with and binds to the surface of the porous membrane. It is noted that both aspiration and expulsion is not required. That is, a device in accordance with the present technology needs to provide only a single interaction (i.e., just one passage through the membrane) for purification.

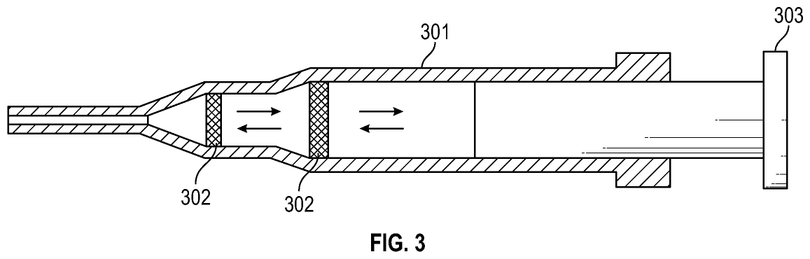

FIG. 3 shows another embodiment of a device in accordance with the present technology. Specifically, FIG. 3 illustrates a syringe device 301 that contains two three-dimensional membranes 302. It is noted that a device in accordance with the present technology can include one, two, three, four or more membranes. In the embodiment shown in FIG. 3, the two membranes 302 are porous three-dimensional membranes with immunoaffinity ligands residing along its accessible surface area. By having two membranes 302, and the ability to aspirate into device 301 and expel out of device 301, a sample containing a target compound is able to interact with the membranes 302 up to four times (sample contact with two membranes in one direction and sample contact another two times with the same membranes in the other direction).

Each membrane 302 has a plurality of immunoaffinity ligands (represented by crisscrossed lines) throughout the accessible surface area formed by the porosity. Aspiration of a sample occurs as a plunger rod 303 is pulled back, creating a suction force that drives the flow of the sample through each membrane. The syringe may then expel the sample by reversing the direction of the plunger rod 303. A cap or luer may be placed on the open end of the device after the first aspiration of sample into the syringe, such that the sample can be pushed and pulled through the membranes 302 more than one time (i.e., a plurality of actuations of rod 303). Each time the sample interacts and flows through the membranes 302, target compounds bind to the immunoaffinity ligands causing target compounds to be extracted from the sample. An elution solution may be used to remove the bound target sample by passing through the device using the same flow path as the sample. The arrows demonstrate that the fluid path of a sample or an elution flow in both directions. An advantage of multiple membranes is that it provides an additional two-time interaction for extraction and purification during the same aspirating and expelling steps of a sample. Moreover, these membranes can vary in thickness based on the desired optimal surface area.

### EXAMPLES

### Example 1: Forming a Device Including Immunoaffinity Ligand-Coated Frits

In order to be able to test the present immunoaffinity membrane technology, devices including a frit with immunoaffinity ligands were formed. To create such devices, aflatoxin Mab was immobilized on a porous plastic structure (a three-dimensional porous polyethylene polymer material (POR-4920) sold under the trademark POREX® and commercially available from the Porex Corporation, Fairburn Georgia) having a thickness of 0.062 inches and a typical median pore size ranging from 15-45 microns. The porous polymer structure was used as the membrane material and was purchased in the form of a frit. After the aflatoxin Mab was immobilized on the porous polymer material to form a coated membrane/frit, the coated frit was secured by a friction frit to the interior surface of a narrow bore column and evaluated for its immunoaffinity capabilities.

The procedure includes the following steps:
1. Pre-wet the POREX® membranes to fit 1 mL narrow bore columns; soak the membranes in 100% methanol; rinse with 1×PBS
2. Prepare 4 mL aflatoxin Mab at 0.5 mg/ml in 1×PBS; OD_{280 nm}=0.759 and 0.756 (OD_{average}=0.757); concentration=0.757/1.4=0.54 mg/ml; Mab content=0.54*4=2.16 mg
3. Add 40 membranes into the Mab solution. Mix end over end for 3 hours. Take the supernatant and scan at 280 nm; OD_{280 nm}=0.054; 0.041 (OD_{average}=0.0475); concentration=0.0475/1.4=0.034 mg/ml; Mab content=0.034*4 mL=0.136 mg; Mab absorbed on POREX® membrane=2.16-0.136=2.02 mg; 2.02 mg/40 membranes=0.05 mg/membrane
4. Rinse the membranes with 1×PBS three times.
5. Dry the membranes:
   a. Dry the membrane at 45° C. for 30 minutes. Store in dry room (humidity <5%) overnight.
   b. Rinse the membranes with 1×PBS and preservative. Dry the frits as in step (a).
6. Store the dry membranes in 15 mL conical tubs with desiccant.

The resulting membranes were designated “A” and “B.” Membrane A represents the fresh wet format of the membrane. Membrane B represents the dry format of the membrane.

### Example 2: Testing the Device Including Immunoaffinity Ligand-Coated Frits

The membranes and devices prepared in Example 1 were then evaluated based on the following steps:
1. Install the membranes into narrow bore column barrels.
   a. Wet membranes from step 4 above.
   b. Dry membranes from step 5(a) above.
2. Prepare 50 ppb aflatoxin spiked 1×PBS; aflatoxin B1:B2:G1:G2=5:1:3:1
3. Load 1 mL aflatoxin spiked PBS onto column A (column with membrane A included) and onto column B (column with membrane B included). Let the solution flow through the frits by gravity.
4. Add 1 mL 1×PBS into the columns. Allow flow by gravity. Purge (expel) the liquid using a syringe.
5. Elute the membrane with 1 mL methanol.
6. Dilute the eluate with Afla-V one diluent. 100 mL eluate+200 mL diluent.
7. Test with Afla-V step (lot 035-040). The calibration was made by spiked methanol:Afla-V one diluent (1:2).

TABLE 1
EVALUATION RESULTS

| Membrane | Sample loaded | T/C | Eluted (ng) |
|---|---|---|---|
| A | 50 ng | 3.03 | 8.3 |
| B | 50 ng | 4.51 | 5.5 |

A typical resin based immunoaffinity column should capture all 50 ng toxin loaded and eluted 50 ng. The frit format column has much smaller volume compared to a traditional resin column (40 μL frit vs 200 μL resin plus 2 frits). Membrane A (fresh wet format) preserved the most antibody activity by capturing 8.3 ng of toxin. However, capacity drops with time since the antibodies are not stable in liquid format. Membrane B (dry format) preserved a substantial amount of binding activity of 5.5 ng. The results demonstrate aflatoxin Mab was successfully immobilized on POREX® membranes. Adding frits with a greater amount of surface area for coating with the ligands and/or adding additional membranes in accordance with the present technology can be used to achieve greater capture.

Specific embodiments and methods of the present technology have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A system for purifying and enriching a sample comprising immunoaffinity ligands immobilized on one or more of a three-dimensional porous membrane wherein the membrane is secured in a device such that the membrane is capable of immunoaffinity binding a target compound when a sample is aspirated or expelled from the device as the sample passes through the membrane.

2. The system of claim 1, wherein the device comprises a column, pipette, and/or a syringe.

3. The system of claim 1, wherein the immunoaffinity ligands are immobilized on the membrane by covalent bonding.

4. The system of claim 1, wherein the immunoaffinity ligands are immobilized on the membrane by passive absorption.

5. The system of claim 1, wherein the membrane is dry when not in contact with a sample.

6. The system of claim 1, wherein the membrane comprises a plastic polymer.

7. The system of claim 1, wherein the immobilized immunoaffinity ligands are capable of capturing from about 5 to 99% by weight of the target compound from the sample.

8. A high throughput instrument comprising the system of claim 1.

9. A method of purifying and enriching a sample comprising aspirating the sample into or expelling the sample from the system of claim 1.
